(19) United States
(12) Patent Application Publication
(10) Pub. No.: US 2002/0001201 A1
(43) Pub. Date: Jan. 3, 2002

(54) Method and system for illuminating an object and light source for use therein

(76) Inventors: Myron J. Czubko, Ann Arbor, MI (US); G. Neil Haven, Martinsville, IN (US); Terry J. Stefanski, Saline, MI (US)

Correspondence Address: David R. Syrowik, Brooks & Kushman P.C., 22nd Floor, 1000 Town Center, Southfield, MI, 48075-1351, US

(21) Appl. No.: 09/802,593

(22) Filed: Mar. 9, 2001

Related U.S. Application Data
(60) Provisional application No. 60/192,791, filed on Mar. 28, 2000.

(51) Int. Cl. G02B 6/04

(52) U.S. Cl. 362/554

(57) ABSTRACT

A method, system and light source provide concentrated illumination from a multi-fiber optical light guide suitable for use where intense illumination is needed. The light from a plurality of high-intensity light emitting diodes is physically coupled into a corresponding plurality of sub-millimeter diameter optical fibers. The optical fibers are combined with appropriate optics to form a flexible illumination system ideal for the intense illumination of small areas. This method and system are designed for applications such as medicine and dentistry where size, weight, wattage, lifetime, and operating temperature of the light source are important considerations.

### CROSS-REFERENCE TO RELATED APPLICATION

This application claims the benefit of U.S. provisional application Ser. No. 60___,___ filed Mar. __, 2000.

### BACKGROUND OF THE INVENTION

1. Field of the Invention

This invention relates to methods and systems for illuminating an object and light sources for use therein. The method, system and light source are particularly useful in medical and dental applications.

2. Background Art

Current art in the area of fiber-optic guided light sources uses gaseous or incandescent bulbs as the illumination source. Examples are xenon sources, metal halide sources, and quartz halogen sources. These sources run at temperatures well above 200 degrees C. and wattages in excess of 150 watts. They tend to be bulky (>5 Kg) because of their power consumption and heat dissipation requirements. In order to provide the illumination necessary for fiber-optic light guides, the bulbs tend to last fewer than 1000 hours.

U.S. Pat. No. 5,667,291 for the Orascoptic™ light guide describes a fiber optic light guide with a flexible, multi-strand fiber optic cable terminating in optics intending to provide illumination for dental procedures. This example of prior art is useful with intense xenon, metal halide, or quartz halogen sources, but is not usable with less-intense light emitting diodes as the illumination source. Since the input aperture of the fiber-optic light guide in the Orascoptic™ invention is less than the diameter of a single light emitting diode, and since a single light emitting diode does not emit enough light to illuminate a dental procedure, the Orascoptic™ invention cannot be used with light emitting diodes as a light source.

The need for low-temperature, long-lived illumination sources is particularly critical in medical applications where the environment can constitute an explosion hazard due to the presence of medical gases such as oxygen and nitrous oxide and where an interruption in a medical procedure due to a burned-out bulb can constitute a hazard to successful completion of the medical procedure.

By using long-lived, high-intensity LED's as the illumination source, the twin requirements of low-temperature and long life are met. LED lifetimes on the order of 100,000 hours are typical. LED power consumption per unit of visible light output is more efficient than traditional incandescent sources by more than an order of magnitude.

Recently available LED sources such as MCDPW500S available from MCD Electronics are capable of providing luminous intensity of more than two candelas over a viewing angle of 15 degrees.

### SUMMARY OF THE INVENTION

An object of the present invention is to provide a method and system for illuminating an object and light source for use therein which are capable of providing high intensity light for illuminating small areas such as in medical and dental applications.

In carrying out the above object and other objects of the present invention, a method is provided for illuminating an object. The method includes controllably emitting light at a first array of separate locations, collecting a portion of the light emitted at the first array of separate locations at a corresponding second array of separate locations adjacent the first array of separate locations and transmitting the light collected at the second array of separate locations to an illumination plane. The method then includes the step of substantially collimating transmitted light passing through the illumination plane to form a frustum of light for illuminating the object.

The second array of separate locations are preferably contained within a planar area greater than an area of the illumination plane.

The object may be part of a living organism such as a human.

The frustum of light may have a single color or multiple colors.

Further in carrying out the above object and other objects of the present invention, a system for illuminating an object is provided. The system includes an array of discrete light sources, a controller for controllably energizing the discrete light sources so that the light sources emit light and a light guide including an array of optical fibers supported adjacent the array of discrete light sources for collecting a portion of light emitted by the array of discrete light sources and transmitting the collected light to an illumination plane. The system further includes an optical element positioned adjacent the illumination plane for substantially collimating transmitted light passing through the illumination plane to form a frustum of light for illuminating the object.

The discrete light sources may include a plurality of LEDs. The plurality of LEDs may include at least one red LED, at least one green LED, and at least one blue LED.

Preferably, each of the optical fibers has a sub-millimeter diameter.

Also, preferably, each of the light sources is capable of providing more than two candelas of luminous intensity over a viewing angle of 15 degrees.

Still further in carrying out the above object and other objects of the present invention, a multi-colored light source for use in a system which illuminates a part of a human with high intensity light is provided. The light source includes a substrate and an array of multi-colored, separately controllable, LEDs supported on the substrate and arranged so that color balance and level of intensity are controllable.

The LEDs may include at least one LED having a first color, at least one LED having a second color, and at least one LED having a third color wherein the first, second and third colors are different from one another. The first color may be red, the second color may be green and the third color may be blue.

The above object and other objects, features, and advantages of the present invention are readily apparent from the following detailed description of the best mode for carrying out the invention when taken in connection with the accompanying drawings.

### BRIEF DESCRIPTION OF THE DRAWINGS

FIG. 1 is a schematic view of a plurality of LEDs and an associated fiber-optic cable;

FIG. 2 is a schematic view, partially broken away, of a fiber-optic cable having an optical element adjacent a distal end of the fiber-optic cable and in close proximity to a surface to be illuminated;

FIG. 3 is a schematic diagram of a plurality of red, green and blue LEDs and associated control circuit elements; and

FIG. 4 is a schematic diagram illustrating a controller, a circuit board of LED sources, a grid of optical fibers, and a fiber-optic bundle.

### DETAILED DESCRIPTION OF THE PREFERRED EMBODIMENT

In accordance with the teachings of this invention, a novel method, system and light source for the illumination of dental and medical procedures are provided which allow the dental or medical practitioner to direct an intense beam of illumination to a desired location. This illumination is produced from a device which has the multiple desirable attributes of low power consumption, low temperature operation, being long-lived, and being small in size and weight.

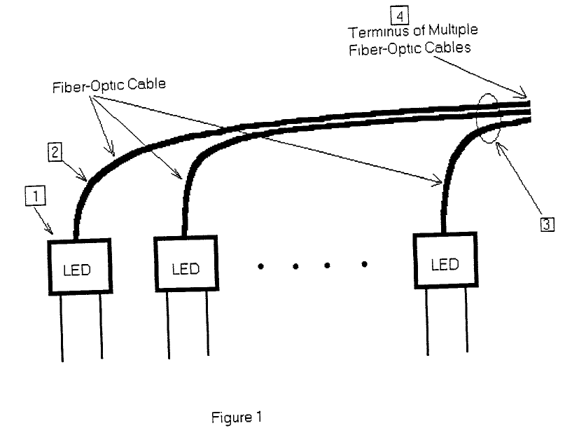

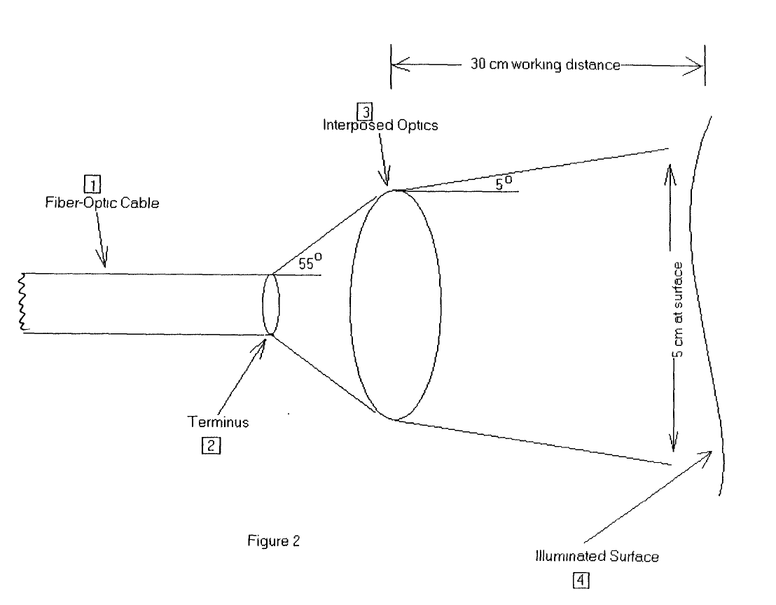

A high-output LED (for example, MCDPW500S available from MCD) is used as a discrete light source. When used in multiples of 100-500, the LEDs are useful for dental and medical illumination. When the light from one of these LED's is coupled into a fiber-optic light guide with sub-millimeter diameter and the light from this single fiber-optic light guide is combined with the light from multiple other so-constituted fiber-optic light guides, a flexible fiber-optic light source is produced with illuminance sufficient for medical and dental micro-surgical requirements. The light from the source [1, FIG. 1] is physically coupled into a single strand of small-diameter fiber-optic cable [2, FIG. 1]. Multiple strands of fiber-optic cable, so-constituted, are combined into a single multi-stranded cable [3, FIG. 1 & 1, FIG. 2]. This multi-stranded cable terminates in a polished illuminating plane [4, FIG. 1 & 2, FIG. 2] whose diameter is determined by the number of small-diameter fiber-optic strands comprising the multi-stranded cable. In a typical embodiment with 100 light emitting diodes and, hence, 100 individual strands of 0.75 mm diameter, the diameter of the multi-stranded cable is approximately 7 mm. Thus, the diameter of the illumination plane is approximately 7 mm.

At a working distance of approximately 30 cm, dentists prefer the field of illumination to be approximately 5 cm in diameter [Figure 2]. This determines an approximately 5 degree spread of light from the terminus [2, FIG. 2] of the multi-strand fiber optic cable [1, FIG. 2]. Since most fiber-optic cable in common use has a natural 55 degree spread of light, it is desirable to interpose optics [3, FIG. 2] between the terminus [2, FIG. 2] and the subject being illuminated [4, FIG. 2] sufficient to collimate the light from the fiber-optic cables to within 5 degrees.

In an optional embodiment, the color-balance of the light emitting from the light source can be varied by choosing LED sources of varied colors (for example, one third red, one third green, one third blue) which, when mixed, give the desired color-balance.

In an optional embodiment, the intensity of the light emitting from the light source can be varied by means of control circuitry which provides for varying the current supplying the LED sources.

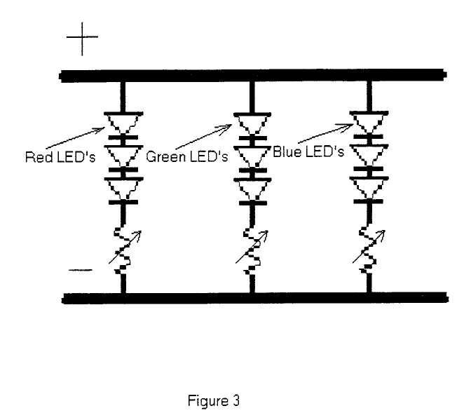

In an optional embodiment, the color-balance and the intensity of the light emitting from the light source can be varied by choosing LED sources of varied colors (for example, one third red, one third green, one third blue) and further providing each set of similar-colored LED sources with intensity control circuitry or a controller by means of which the intensity of each set of said LED sources can be independently varied [FIG. 3].

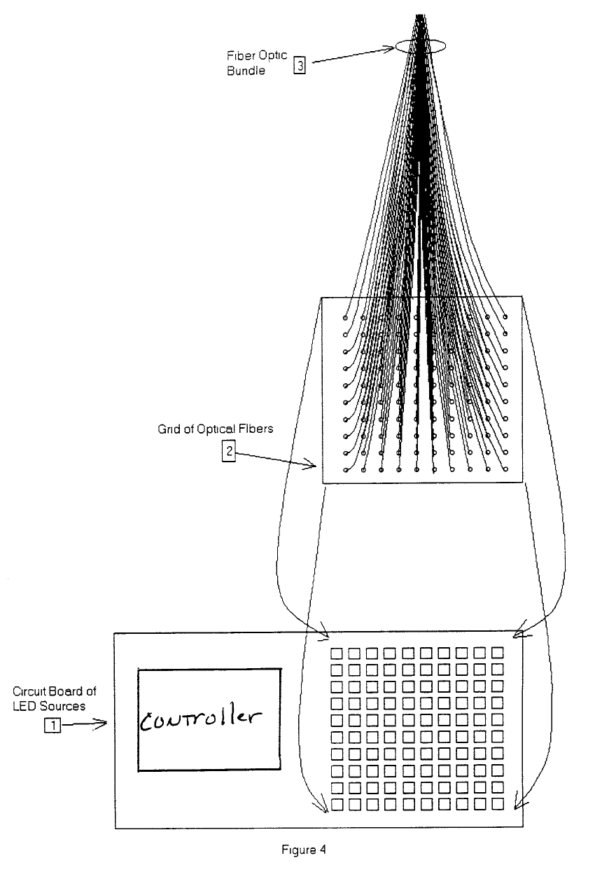

FIG. 4 shows a schematic of the multiple components of this device. A circuit board [1, FIG. 4] constructed by means well known to the art contains 100 regularly-spaced LED's such as the MCDPW500S manufactured by MCD Electronics. In accordance with the optional embodiments of this invention, the LED's may be all of one color or may be multi-colored. The color-balance of the light produced when the light from these LED's is mixed may be controlled by intensity control circuitry by means of which the intensity of the variously colored LED's may be independently varied [FIG. 3].

The light produced from these LED's is captured by means of a grid [2, FIG. 4] of fiber optic cables such as the K02-533 0.75 mm unjacketed optical grade fiber sold by Edmund Scientific which are arrayed to be aligned with the grid of regularly-spaced LED's. This grid may be constructed from a dielectric material (such as plastic) into which a grid of 0.75 mm holes has been drilled which correspond in spacing to the spacing of the LED's on the circuit board. A length of 0.75 mm optical fiber is inserted into each of these holes at a pre-determined depth and glued in place.

The multi-strand bundle optical fibers are gathered into a cylindrical bundle [3, FIG. 4] and jacketed with a flexible, protective material. The ends of all the individual fibers are aligned and fused with acrylic cement. The exposed end of the bundle is then polished at the illumination plane and fitted with optics to ensure a 5 cm field of illumination at a working distance of 30 cm as illustrated in FIG. 2.

In general, to those skilled in the art to which this invention relates, many changes in construction and widely differing embodiments and applications of the present invention will suggest themselves without departing from its spirit and scope. Thus the disclosures and descriptions herein are purely illustrative and are not intended to be in any sense limiting.

While the best mode for carrying out the invention has been described in detail, those familiar with the art to which this invention relates will recognize various alternative designs and embodiments for practicing the invention as defined by the following claims.

What is claimed is:

1. A method for illuminating an object, the method comprising:
controllably emitting light at a first array of separate locations;
collecting a portion of the light emitted at the first array of separate locations at a corresponding second array of separate locations adjacent the first array of separate locations;
transmitting the light collected at the second array of separate locations to an illumination plane; and
substantially collimating transmitted light passing through the illumination plane to form a frustum of light for illuminating the object.

2. The method of claim 1 wherein the second array of separate locations are contained within a planar area greater than an area of the illumination plane.

3. The method of claim 1 wherein the object is part of a living organism.

4. The method of claim 3 wherein the living organism is an animal.

5. The method of claim 4 wherein the animal is a human.

6. The method of claim 1 wherein the frustum of light has a single color.

7. The method of claim 1 wherein the frustum of light has multiple colors.

8. A system for illuminating an object, the system comprising:
an array of discrete light sources;
a controller for controllably energizing the discrete light sources so that the light sources emit light;
a light guide including an array of optical fibers supported adjacent the array of discrete light sources for collecting a portion of light emitted by the array of discrete light sources and transmitting the collected light to an illumination plane; and
an optical element positioned adjacent the illumination plane for substantially collimating transmitted light passing through the illumination plane to form a frustum of light for illuminating the object.

9. The system as claimed in claim 8 wherein the discrete light sources include a plurality of LEDs.

10. The system as claimed in claim 9 wherein the plurality of LEDs include at least one red LED.

11. The system as claimed in claim 9 wherein the plurality of LEDs include at least one green LED.

12. The system as claimed in claim 9 wherein the plurality of LEDs include at least one blue LED.

13. The system as claimed in claim 8 wherein the array of optical fibers are contained within a planar area greater than an area of the illumination plane.

14. The system as claimed in claim 8 wherein the object is part of a living organism.

15. The system as claimed in claim 14 wherein the living organism is an animal.

16. The system as claimed in claim 15 wherein the animal is a human.

17. The system as claimed in claim 8 wherein each of the optical fibers has a sub-millimeter diameter.

18. The system as claimed in claim 8 wherein each of the light sources is capable of providing more than two candelas of luminous intensity over a viewing angle of 15 degrees.

19. A multi-colored light source for use in a system which illuminates a part of a human with high intensity light, the light source comprising:
a substrate; and
an array of multi-colored, separately controllable, LEDs supported on the substrate and arranged so that color balance and level of intensity are controllable.

20. The light source as claimed in claim 19 wherein the LEDs include at least one LED having a first color, at least one LED having a second color, and at least one LED having a third color and wherein the first, second and third colors are different from one another.

21. The light source as claimed in claim 20 wherein the first color is red, the second color is green and the third color is blue.
